(19) United States
(12) Patent Application Publication
(10) Pub. No.: US 2026/0192627 A1
(43) Pub. Date: Jul. 9, 2026

(54) A COMPUTER-IMPLEMENTED METHOD FOR INITIATING PRECONDITIONING OF A VEHICLE SYSTEM OR COMPONENT

(71) Applicant: VOLVO AUTONOMOUS SOLUTIONS AB, Göteborg (SE)

(72) Inventors: Oscar STJERNBERG, Göteborg (SE); Martin WILHELMSSON, Göteborg (SE)

(21) Appl. No.: 19/131,829

(22) PCT Filed: Nov. 28, 2022
(86) PCT No.: PCT/EP2022/083521

§ 371 Date: May 21, 2025

(51) Int. Cl. B60H 1/00; B60L 58/24; B60L 58/32; F02N 19/02

(52) U.S. Cl. CPC B60H 1/00735; B60L 58/24; B60L 58/32; F02N 19/02

(57) ABSTRACT

A computer-implemented method for initiating a preconditioning of at least one vehicle system or component of a primary vehicle, including:
identifying that the primary vehicle is being transported by a secondary vehicle,
determining a preconditioning starting time based on an expected arrival time of the secondary vehicle to a target location, the preconditioning starting time being prior to the expected arrival time, and
initiating the preconditioning of the at least one vehicle system or component at the determined preconditioning starting time.

### TECHNICAL FIELD

The disclosure relates generally to preconditioning of vehicle systems or components. In particular aspects, the disclosure relates to a computer-implemented method for initiating preconditioning of a vehicle system or component. The disclosure can be applied in heavy-duty vehicles, such as trucks, buses, and construction equipment. Although the disclosure may be described with respect to a particular vehicle, the disclosure is not restricted to any particular vehicle.

### BACKGROUND

Most vehicles have an optimal temperature operating range. For vehicles powered by a combustion engine, the optimal temperature operating range could be around 80-90° C., for battery electric vehicles around 35-40° C., and for fuel cell electric vehicles around 50° C. If the temperature is above or below the optimal temperature operating range, the energy efficiency of the vehicle may be reduced, in particular for fuel cell electric vehicles and battery electric vehicles. For combustion engine powered vehicles, the emission levels may increase when the temperature is below the optimal temperature operating range, such as when the engine is cold started.

To reduce the negative effects of cold starting a vehicle, preconditioning of vehicle systems or components may be carried out prior to take-off, such as by using an engine pre-heater or similar. The preconditioning may be carried out to reach a desired temperature range before starting, by warming and/or cooling components and/or systems as necessary.

### SUMMARY

According to a first aspect of the disclosure, a computer-implemented method for initiating a preconditioning of at least one vehicle system or component of a primary vehicle according to claim 1 is provided. The method comprises:
identifying, by a processor device of a computer system, that the primary vehicle is being transported by a secondary vehicle,
determining, by the processor device, a preconditioning starting time based on an expected arrival time of the secondary vehicle to a target location, the preconditioning starting time being prior to the expected arrival time,
initiating, by the processor device, the preconditioning of the at least one vehicle system or component at the determined preconditioning starting time.

The first aspect of the disclosure may seek to reduce problems associated with cold start arising when a primary vehicle arrives at a target location after having been transported by a secondary vehicle, such as by a train, a truck, or a ferry. By determining a preconditioning starting time based on the expected arrival time, and initiating the preconditioning at that time, it is possible to arrive at the target location with the at least one vehicle system or component, such as an engine, an electric motor, an aftertreatment system or component, a sensor, an electric energy storage system, a fuel cell system or component, a vehicle cabin, etc., in a desired temperature range. Problems associated with cold start, such as reduced energy efficiency, reduced functionality, reduced comfort, and/or increased emission levels, can thereby be reduced.

Optionally, identifying that the primary vehicle is being transported comprises:
determining a geographic position of the primary vehicle,
identifying that the primary vehicle is moving based on the determined geographic position,
receiving sensor data and/or vehicle state data from at least one sensor and/or device of the primary vehicle, and
determining that the primary vehicle is in a parked state based on the received sensor data and/or vehicle state data.

In this way, it can be established that the primary vehicle is parked while being transported by using sensors and devices normally present in the primary vehicle. The sensor data may be data from, e.g., a wheel sensor, a tachometer, a camera, or similar, that indicates that the primary vehicle is not moving relative to a supporting surface on which it is located. The vehicle state data may be information relating to a vehicle state of the primary vehicle, such as information that an engine or an electric motor of the primary vehicle is turned off.

Depending on a configuration of the sensor, the absence of received sensor data from, e.g., a tachometer or wheel sensor, may further be regarded as indicating that the vehicle is in a parked state. In such a case, the method may comprise determining that the vehicle is in a parked state based on an absence of received valid sensor data. In some examples, the method may comprise determining that the vehicle is in a parked state unless valid sensor data are received, indicating that the primary vehicle is moving relative to the supporting surface on which it is located.

Optionally, determining the geographic position of the primary vehicle comprises receiving geographic position data indicative of the geographic position of the primary vehicle from a satellite navigation device of the primary vehicle, and identifying that the primary vehicle is moving comprises detecting that the geographic position data are indicative of a movement. Hence, the geographic position is monitored and when a change in the geographic position is detected, it is identified that the primary vehicle is moving.

Optionally, the method further comprises identifying that the primary vehicle is being transported along a known transport route. The known transport route may be a route along which the primary vehicle has previously been transported, or a transport route stored in a database. The known transport route may have at least a known starting location. It may further have at least one of a known target location and a known expected total travel time. It may further have a known geographic extension between the starting location and the target location.

Optionally, the method further comprises obtaining statistical and/or historical data associated with the known transport route. The statistical and/or historical data may thereby be used to identify that the vehicle is travelling along the known transport route, and further to determine the expected arrival time with a high accuracy. The statistical and/or historical data may comprise geographic position data relating to the starting and/or target location, and optionally a geographic extension between the staring and target location. The data may further comprise time data relating to a total travel time along the transport route.

Optionally, the statistical and/or historical data comprise data collected by the primary vehicle in connection with at least one previous transport along the known transport route.

Optionally, the statistical and/or historical data comprise data collected by at least one other vehicle in connection with transport along the known transport route. Hence, data from several vehicles may be used to improve the accuracy in the identification of the transport route and in determining the expected arrival time.

Optionally, identifying that the primary vehicle is being transported along the known transport route comprises detecting that the primary vehicle has reached a known starting location of the known transport route, and based on the statistical and/or historical data associated with the known transport route determining that the primary vehicle is being transported. This may be useful if a geographic position signal is lost during transport on the secondary vehicle, in which case historical data may be used to establish that the arrival at the starting location with a high probability leads to boarding onto a secondary vehicle and transport along the known transport route. The detection that the known starting location is reached may be based on geographic position data or based on sensor data received from a sensor within the primary vehicle, such as from a camera, or based on user input via a user interface, e.g., by a driver confirming that the starting location is reached. Determining that the primary vehicle is being transported may comprise making an educated guess or assumption based on the statistical and/or historical data, e.g., based on how the primary vehicle has previously been transported or operated after reaching the known starting location, or on how other vehicles have been transported or operated after reaching the known starting location.

Optionally, the method further comprises predicting the expected arrival time of the secondary vehicle to the target location based on the historical and/or statistical data associated with the known transport route. The expected arrival time may be determined based on a statistical average total travel time. To improve the accuracy, weather data and/or traffic data may be taken into account to, e.g., predict a delay in comparison with the statistical average total travel time.

Optionally, the at least one vehicle system or component comprises at least one of: an engine, an electric motor, a fuel cell system or component, an exhaust system or component, such as an aftertreatment system or a component of an aftertreatment system, an electric energy storage system or component, and a vehicle cabin. Any one of those systems/components may be useful to precondition by either warming or cooling to a desired temperature interval, or at least to a temperature closer to the desired temperature interval than the temperature that would result without preconditioning. For a combustion engine, the desired temperature interval may be 80-90° C., for an electric energy storage system comprising one or more batteries the desired temperature interval may be 35-40° C., for a fuel cell system the desired temperature interval may be 45-55° C. A desired temperature interval for an electric motor may be 60-70° C., for a vehicle cabin a desired temperature interval may be 15-25° C., while as a desired temperature for a sensor such as a NOx sensor in an exhaust system may be about 800° C.

Optionally, initiating the preconditioning of the at least one vehicle system or component comprises initiating a preheating of at least one first vehicle system or component, and/or a precooling of at least one second vehicle system or component. The preheating and/or the precooling may be adapted to reach a desired temperature interval when arriving at the target location. The desired set temperature may differ between different systems and components within the primary vehicle as described above. The preconditioning may, e.g., be performed to raise the temperature of an exhaust system component, while simultaneously reducing the temperature of the vehicle cabin. A different preconditioning starting time may be set for different components or systems, depending on e.g., the energy needed for cooling or heating, and the cooling/heating capacity of a cooling/heating system used for the preconditioning.

According to a second aspect of the disclosure, a computer system comprising a processor device configured to initiate a preconditioning of at least one vehicle system or component of a primary vehicle is provided. The processor device is configured to:
identify that the primary vehicle is being transported by a secondary vehicle,
determine a preconditioning starting time based on an expected arrival time of the secondary vehicle to a target location, the preconditioning starting time being prior to the expected arrival time,
initiate the preconditioning of the at least one vehicle system or component at the determined preconditioning starting time.

According to a third aspect of the disclosure, a vehicle comprising the processor device configured to perform the method of the first aspect is provided.

According to a fourth aspect of the disclosure, a computer program product comprising program code for performing, when executed by a processor device, the method according to the first aspect, is provided.

According to a fifth aspect of the disclosure, a control system comprising one or more control units configured to perform the method according to the first aspect is provided.

According to a sixth aspect of the disclosure, a non-transitory computer-readable storage medium is provided. The non-transitory computer-readable storage medium comprises instructions, which when executed by a processor device, cause the processor device to perform the method according to the first aspect.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 illustrates a primary vehicle according to one example.

FIG. 2 illustrates transport of the primary vehicle by a secondary vehicle.

FIG. 3 illustrates probability of arriving at a target location as a function of time along a transport route.

FIG. 4 is a flow chart illustrating a method according to an example.

FIG. 5 is another flow chart illustrating a method according to an example.

FIG. 6 is a schematic diagram of an exemplary control system for implementing examples disclosed herein, according to one example.

The drawings show diagrammatic exemplifying embodiments of the present disclosure and are thus not necessarily drawn to scale. It shall be understood that the embodiments shown and described are exemplifying and that the disclosure is not limited to these embodiments. It shall also be noted that some details in the drawings may be exaggerated in order to better describe and illustrate the disclosure. Like reference characters refer to like elements throughout the description, unless expressed otherwise.

Aspects set forth below represent the necessary information to enable those skilled in the art to practice the disclosure.

The present disclosure aims at enabling preconditioning of a primary vehicle during transport by a secondary vehicle, so as to reduce problems with emissions and/or low energy efficiency arising due to a cold start of the vehicle when the secondary vehicle reaches its target destination, and the primary vehicle is to take off.

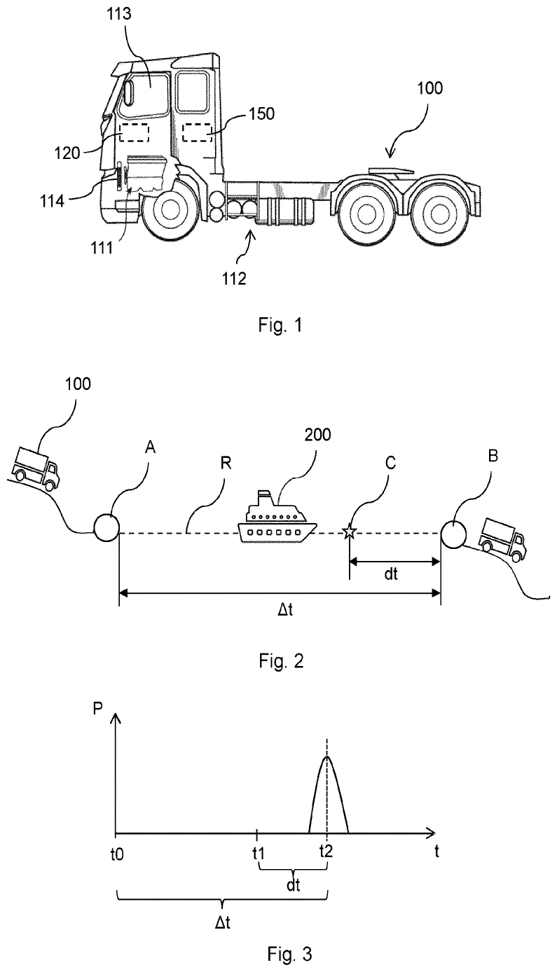

FIG. 1 is a side view of a primary vehicle 100 in which a method according to an example of the disclosure may be carried out. The vehicle 100 in FIG. 1 is a truck, or more specifically a towing truck for towing one or more trailers (not shown). The primary vehicle 100 includes an internal combustion engine 111 for propulsion of the vehicle 100, and an exhaust system including an exhaust aftertreatment system (EATS) 112 for guiding and handling exhaust gases generated by the internal combustion engine 111. The primary vehicle 100 further comprises a vehicle cabin 113 in which a driver's seat (not shown) is located. The EATS 112 may comprise several different aftertreatment components and sensors (not shown), such as catalyst substrate(s), particulate filter(s), temperature sensor(s) and/or emission sensor(s), e.g., a nitrogen oxide (NOx) sensor.

In order to reduce emissions, improve energy efficiency and driver comfort at takeoff of the primary vehicle 100, it may be desirable to precondition one or more components or systems of the primary vehicle 100. In the exemplified primary vehicle 100, such components or systems include, e.g., the engine 111, one or more components of the EATS 112, and the vehicle cabin 113. There may be an optimal temperature range of each one of those components and systems, which temperature range is desirable to reach prior to starting the primary vehicle 100. The different optimal temperature ranges may differ significantly depending on the component or system. For example, the NOx sensor may require a temperature of about 800° C. for optimal function, while the engine 111 should preferably operate at a temperature of 80-90° C., and the vehicle cabin 113 may preferably be at a temperature comfortable for the driver, such as room temperature. Depending on an ambient temperature, the preconditioning may comprise preheating and/or precooling of the various components. The preheating or precooling may be effected using one or more heating and/or cooling systems of the primary vehicle 100, such as an engine cooling/heating system 114 comprising a radiator and a fan, an electric heater (not shown) for heating components of the EATS 112, a cabin heater/cooler (not shown), etc. The heating and/or cooling systems may preferably use an electric energy source for the heating and/or cooling, such as a vehicle battery (not shown).

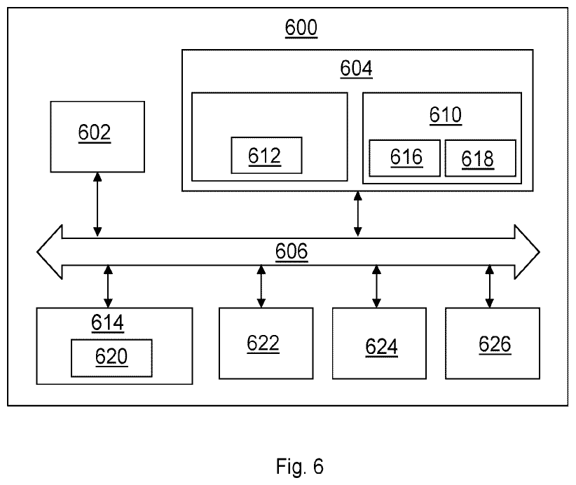

The primary vehicle 100 is equipped with a navigation system comprising a satellite navigation device 120 configured to detect and communicate a geographic position of the primary vehicle 100, such as coordinates of the primary vehicle 100. The primary vehicle 100 is further equipped with a control system comprising one or more electronic control units 150, also referred to as one or more processor devices, which will be described in further detail with reference to FIG. 6. The control system may be configured to control the one or more heating and/or cooling systems of the primary vehicle 100 to effect preconditioning of the various components and systems.

Even though the primary vehicle 100 is exemplified as powered by a combustion engine 111, the primary vehicle 100 may alternatively be an electric vehicle which at least partly uses electric power for propulsion, such as a battery electric vehicle or a fuel cell electric vehicle, or a hybrid vehicle comprising an internal combustion engine and one or more electric motors for propulsion. In those cases, it may be desirable to precondition, e.g., a fuel cell system, an electric energy storage system, and/or the electric motor(s) of the vehicle. Even though the depicted primary vehicle 100 is a truck 100, it shall be noted that the primary vehicle 100 may be any type of vehicle, such as a bus, a working machine, etc.

FIG. 2 schematically illustrates transport of a primary vehicle 100, such as the vehicle 100 depicted in FIG. 1, by a secondary vehicle 200 in the form of a ferry from a starting location A to a target location B along a transport route R. It is to be noted that the secondary vehicle 200 may be any kind of vehicle which is able to transport the primary vehicle 100, such as a ferry, a train or a truck. For example, a primary vehicle in the form of an excavator or another working machine may be transported by a truck to a working location. A total travel time At of the transport along the transport route R may be known or predicted from historical and/or statistical data. FIG. 3 schematically illustrates a probability P of arriving at the target location B as a function of time t, based on historical and/or statistical data, that may be used to predict the total travel time At. In order for the primary vehicle 100 to arrive at the target location B with the one or more components or systems discussed above preconditioned, it is necessary to initiate the preconditioning prior to arrival. In the example illustrated in FIG. 2, the preconditioning is initiated at a preconditioning starting location C, at which an expected remaining time dt until arrival at the target location B is deemed sufficient for reaching a desired temperature of the one or more vehicle components or systems.

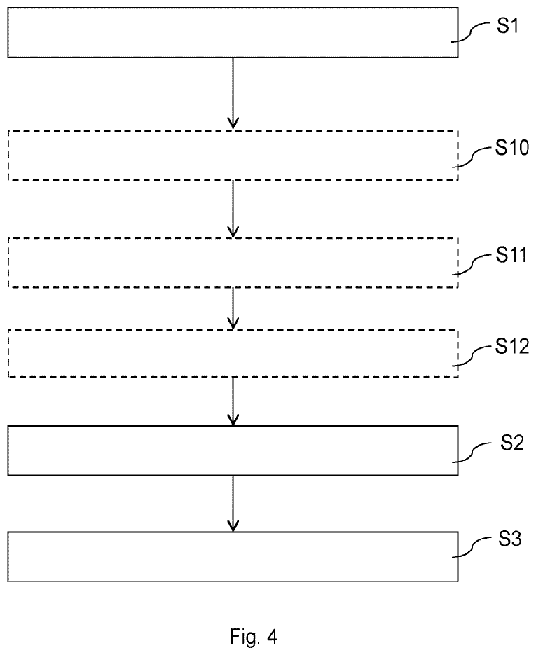

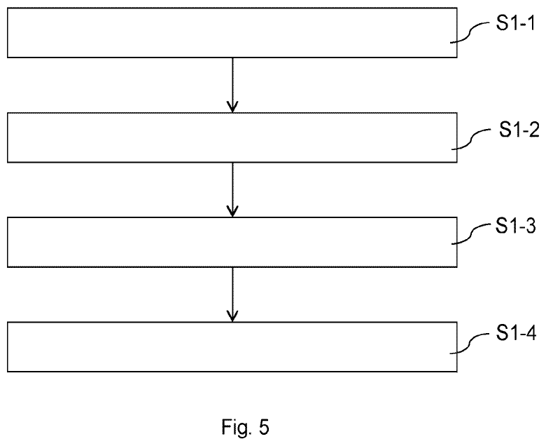

FIG. 4 is a flow chart illustrating a method for initiating a preconditioning of at least one vehicle system or component of a primary vehicle 100 according to an example of the present disclosure. When the primary vehicle 100 is the vehicle 100 depicted in FIG. 1, the vehicle system or component may, e.g., be any one or more of the engine 111, one or more components of the EATS 112, and the vehicle cabin 113. The method comprises the actions listed below, which may be taken in any suitable order. All actions may be carried out by a processor device of a computer system, such as by the control unit 150 depicted in FIG. 1.
S1: Identifying that the primary vehicle 100 is being transported by a secondary vehicle 200, such as by a ferry, a train or a truck. The action S1 may be carried out in different ways. An example of how the action may be carried out is schematically shown in FIG. 5. The action S1 herein comprises an action S1-1 of determining a geographic position of the primary vehicle 100, e.g., by receiving geographic position data indicative of the geographic position of the primary vehicle 100 from the satellite navigation device 120 of the primary vehicle 100. The action S1 may further comprise an action S1-2 of identifying that the primary vehicle 100 is moving, based on the determined geographic position. This may comprise detecting that the geographic position data are indicative of a movement. The action S1 may further comprise an action S1-3 of receiving sensor data from at least one sensor of the primary vehicle 100, and/or vehicle state data from at least one device of the primary vehicle 100, which sensor data and/or vehicle state data are indicative of the primary vehicle 100 being parked. The sensor data may be data from a sensor that senses e.g., rotation of a wheel or another component of a vehicle driveline, such as a tachometer or a wheel sensor.

The sensor data may further be data from a radar, a lidar, a camera or similar, detecting movement of the primary vehicle 100 relative to a supporting surface on which the primary vehicle 100 is located. The vehicle state data may be data from e.g., an engine control unit or an electric motor control unit of the primary vehicle 100, indicating that the engine or electric motor is turned off. The action S1 may herein further comprise an action S1-4 of determining that the primary vehicle 100 is in a parked state based on the received sensor data and/or vehicle state data.
S2: Determining a preconditioning starting time t1 based on an expected arrival time t2 of the secondary vehicle 200 to a target location B, the preconditioning starting time t1 being prior to the expected arrival time t2. The preconditioning starting time t1 may e.g., be selected based on a known or a calculated time for reaching a desired temperature value or interval. The time for reaching a desired temperature may be determined with sufficient accuracy from historical data and/or by using a mathematical model to predict an amount of energy necessary to heat the component or system to the desired temperature value or interval. With reference to FIG. 3, the expected arrival time t2 may be determined based on a starting time t0 of the transport along the transport route R and a statistical average travel time At.
S3: Initiating the preconditioning of the at least one vehicle system or component at the determined preconditioning starting time t1. The action S3 may comprise activating at least one of the one or more heating and/or cooling systems of the primary vehicle 100 and control the heating and/or cooling system(s) to achieve a target temperature within a desired temperature interval. The preconditioning may be initiated by initiating a preheating of at least one first vehicle system or component, such as an EATS 112 or a component thereof, e.g., a NOx sensor, and/or an engine 111, and/or a precooling of at least one second vehicle system or component, such as a vehicle cabin 113.

The method may further comprise an action S10 of identifying that the primary vehicle 100 is being transported along a known transport route R, such as a previously travelled route R or a route R that has been travelled by other vehicles communicating data available to the primary vehicle 100. The method may herein further comprise an action S11 of obtaining statistical and/or historical data associated with the known transport route R from a data source, such as from a cloud server or from a server or database provided within the primary vehicle 100. The statistical and/or historical data may comprise data collected by the primary vehicle 100 in connection with at least one previous transport along the known transport route R, and/or data collected by at least one other vehicle in connection with transport along the known transport route R such as geographic position data and data relating to a travel time along the transport route R, e.g., spatial temporal data.

The action S10 of identifying that the primary vehicle 100 is being transported along the known transport route R may comprise detecting that the primary vehicle 100 has reached a known starting location A of the known transport route R and based on the statistical and/or historical data associated with the known transport route R determining that the primary vehicle 100 is being transported. It may also be identified that a current geographic position of the primary vehicle 100 is along a known transport route R, and from the identified geographic position determine that the primary vehicle 100 is being transported.

The method may further comprise an action S12 of predicting the expected arrival time t2 of the secondary vehicle 200 to the target location B based on the historical and/or statistical data associated with the known transport route R. The prediction may be based on a statistical average travel time At as discussed above.

FIG. 6 is a schematic diagram of a computer system 600 for implementing examples disclosed herein, such as in the vehicle 100 illustrated in FIG. 1. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, the computer system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein, such as the electronic control unit 150 illustrated in FIG. 1. The computer system 600 may include one or more electronic control units 602, which may also be referred to as a processor device, a memory 604, and a system bus 606. The computer system 600 may include at least one computing device having the control unit 602. The system bus 606 provides an interface for system components including, but not limited to, the memory 604 and the control unit 602. The control unit 602 may include any number of hardware components for conducting data or signal processing or for executing computer code stored in memory 604. The control unit 602 (e.g., processor device) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The control unit may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the control unit 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with a control unit 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program product 620 stored on a transitory or non-transitory computer-usable or computer-readable storage medium (e.g., single medium or multiple media), such as the storage device 614, which includes complex programming instructions (e.g., complex computer-readable program code) to cause the control unit 602 to carry out the steps described herein. Thus, the computer-readable program code can comprise software instructions for implementing the functionality of the examples described herein when executed by the control unit 602. The control unit 602 may serve as a controller or control system for the computer system 600 that is to implement the functionality described herein, such as in the control unit 150 illustrated in FIG. 1.

The computer system 600 also may include an input device interface 622 (e.g., input device interface and/or output device interface). The input device interface 622 may be configured to receive input and selections to be communicated to the computer system 600 when executing instructions, such as from a keyboard, mouse, touch-sensitive surface, etc. Such input devices may be connected to the processor device 602 through the input device interface 622 coupled to the system bus 606 but can be connected through other interfaces such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may also include a communications interface 626 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1-16. (canceled)

17. A computer-implemented method for initiating a preconditioning of at least one vehicle system or component of a primary vehicle, comprising:
identifying, by a processor device of a computer system, that the primary vehicle is being transported by a secondary vehicle,
determining, by the processor device, a preconditioning starting time based on an expected arrival time of the secondary vehicle to a target location, the preconditioning starting time being prior to the expected arrival time, and
initiating, by the processor device, the preconditioning of the at least one vehicle system or component at the determined preconditioning starting time,
the method further comprising:
identifying that the primary vehicle is being transported along a known transport route,
obtaining statistical and/or historical data associated with the known transport route, and
predicting the expected arrival time of the secondary vehicle to the target location based on the historical and/or statistical data associated with the known transport route.

18. The method according to claim 17, wherein identifying that the primary vehicle is being transported comprises:
determining a geographic position of the primary vehicle,
identifying that the primary vehicle is moving based on the determined geographic position,
receiving sensor data and/or vehicle state data from at least one sensor and/or device of the primary vehicle, and
determining that the primary vehicle is in a parked state based on the received sensor data and/or vehicle state data.

19. The method according to claim 18, wherein determining the geographic position of the primary vehicle comprises receiving geographic position data indicative of the geographic position of the primary vehicle from a satellite navigation device of the primary vehicle, and wherein identifying that the primary vehicle is moving comprises detecting that the geographic position data are indicative of a movement.

20. The method according to claim 17, wherein the statistical and/or historical data comprise data collected by the primary vehicle in connection with at least one previous transport along the known transport route.

21. The method according to claim 17, wherein the statistical and/or historical data comprise data collected by at least one other vehicle in connection with transport along the known transport route.

22. The method according to claim 17, wherein identifying that the primary vehicle is being transported along the known transport route comprises detecting that the primary vehicle has reached a known starting location of the known transport route (R), and based on the statistical and/or historical data associated with the known transport route (R) determining that the primary vehicle is being transported.

23. The method according to claim 17, wherein the at least one vehicle system or component comprises at least one of: an engine, an electric motor, a fuel cell system or component, an exhaust system or component, an electric energy storage system or component, and a vehicle cabin.

24. The method according to claim 17, wherein initiating the preconditioning of the at least one vehicle system or component comprises initiating a preheating of at least one first vehicle system or component, and/or a precooling of at least one second vehicle system or component.

25. A computer system comprising a processor device configured to initiate a preconditioning of at least one vehicle system or component of a primary vehicle, the processor device being configured to:
identify that the primary vehicle is being transported by a secondary vehicle,
determine a preconditioning starting time based on an expected arrival time of the secondary vehicle to a target location, the preconditioning starting time being prior to the expected arrival time, and
initiate the preconditioning of the at least one vehicle system or component at the determined preconditioning starting time, the processor device further being configured to:
identify that the primary vehicle is being transported along a known transport route,
obtain statistical and/or historical data associated with the known transport route, and
predict the expected arrival time of the secondary vehicle to the target location based on the historical and/or statistical data associated with the known transport route.

26. A vehicle comprising the processor device configured to perform the method of claim 17.

27. A computer program product comprising program code for performing, when executed by the processor device, the method of claim 17.

28. A control system comprising one or more control units configured to perform the method according to claim 17.

29. A non-transitory computer-readable storage medium comprising instructions, which when executed by the processor device, cause the processor device to perform the method of claim 17.
